(19) United States
(12) Patent Application Publication
(10) Pub. No.: US 2013/0050198 A1
(43) Pub. Date: Feb. 28, 2013

(54) MULTI-DIRECTIONAL DISPLAY

(71) Applicant: Jim J. Song, Stockbridge, GA (US)

(72) Inventor: Jim J. Song, Stockbridge, GA (US)

(73) Assignee: Innovare Solutions, LLC, San Diego, CA (US)

(21) Appl. No.: 13/429,307

(22) Filed: Mar. 23, 2012

Related U.S. Application Data
(63) Continuation-in-part of application No. 13/218,312, filed on Aug. 25, 2011.

(51) Int. Cl. G06T 3/60; G06T 15/00

(52) U.S. Cl. 345/419

(57) ABSTRACT

A system and method for generating a multi-directional display is disclosed. An image is generated on a screen. The screen is a display having an image refresh rate, an x-axis and a y-axis defining the height and length of the screen, respectively, and a z-axis orthogonal to the screen. The screen is rotated about the x-axis at a rotational speed relative to the image refresh rate, such that the image on the screen is visible without a perceptible flicker at the z-axis in all directions around the screen.

### CROSS-REFERENCE TO RELATED APPLICATIONS

The current application is a continuation-in-part of co-pending application for U.S. patent application Ser. No. 13/218,312, filed on Aug. 25, 2011 and entitled “Holographic Display,” which the disclosures of the priority application is incorporated by reference herein.

### BACKGROUND

This disclosure relates generally to display technology, and more particularly to generating a multi-directional display using a rotating screen.

Modern computer technology allows for advanced rendering of complex, virtual environments at high frame rates. The use of this technology can be seen in some of today's movies, TV shows and video games. Vast amount of computer power, in combination with various polarized displays or synchronized shutter glasses, also enables creation of stereoscopic views for simulating three-dimensional displays. However, these techniques are still expensive and complex, and are difficult to implement.

Screen technology, such as with televisions and computers, has advanced to the point where the human eye can no longer distinguish the increase in the refresh rate of the screen. Some modern televisions refresh at a rate of 240 Hz, while computer LCD/LED screens refresh at even faster rates. Despite such fast refresh rates, an acceptable viewing angle of the screen remains fairly narrow, and an image or video on a screen that is viewed at too high an angle of incidence can by unclear and difficult to see. A viewing angle of a typical screen is at most 180 degrees. In other words, if a viewer stands 90 degrees to either the left or right relative to the front of the screen, the viewer will no longer be able to see the picture.

In most stores, shopping malls or airports, there are normally multiple televisions or computer screens displaying common images or video information. The reason for this is because each screen can only provide viewing to a limited angle. In other words, if a person is standing directly in front of the display, a person behind the display is not able to view the image. Accordingly, in places where screens are arranged for viewing from multiple varied vantage points within the place, a large number of screens, dispersed about the place, is usually required, adding expenses and consuming maintenance resources. Thus, what is needed is a screen that can be viewed from any angle.

### SUMMARY

In general, this document discloses a multi-directional display system. The multi-directional display in accordance with implementations described herein provides a rich multi-dimensional experience without the aid of additional peripherals. The multi-directional display can provide a rich visual experience from all angles to a display by utilizing the processing capabilities of graphics processing units (GPUs) and central processing units (CPUs) of conventional computing platforms, servers, desktop computers, laptops, smartphones, tablet computers, etc., and rotating displays.

The multi-directional display uses one or more flat panel displays that are rotated in synchronization with images produced by a computer. The display can be a liquid crystal display (LCD), light emitting diode (LED) display, organic LED (OLED) display, or active-matrix OLED (AMOLED) display, from any of a number of devices, such as mobile devices like phones, laptops, and digital cameras, as well as larger devices like computer screens, or large panel television displays. It will be appreciated that other types of displays and devices can be used.

In one aspect, a method for generating a multi-directional display is executed using one or more computer processors. The method includes placing an iPhone on a rotating platform where it primary axis of rotation is around the y-axis (refer to FIG. 1 and FIG. 4). The multi-directional display system screen can be rotated in a clockwise or counter-clockwise direction. The system should be rotated at speeds fast enough the human eye does not easily perceive rotation.

In another aspect, a computer processor-implemented method for generating a multi-directional display includes using a complete (all-in-one) computer such as an iMac. The setup would be the same as for the iPhone, except everything would be of larger scale. Other suitable screens include a flat screen television or any other flat viewable screen that can be rotated.

As described herein, a method for generating a multi-directional display includes the step of generating an image on a screen, such as a digital display. The screen has an image refresh rate, an x-axis and a y-axis defining the height and length of the screen, respectively, and a z-axis orthogonal to the screen. The method further includes the step of rotating the screen about the x-axis at a rotational speed relative to the image refresh rate, such that the image on the screen is visible at the z-axis in all directions around the screen.

As further described herein, a system for generating a multi-directional display includes an electronic display that displays an image on a screen. As described above, the screen has an image refresh rate, an x-axis and a y-axis defining the height and length of the screen, respectively, and a z-axis orthogonal to the screen. The system further includes a rotation mechanism that rotates the electronic display at a rotational rate that is related to the image refresh rate such that the image on the screen is visible at the z-axis in all directions around the screen.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a simulated three-dimensional or holographic display.

FIG. 2 illustrates an image of a computer model at an initial orientation about the x, y and z axes.

FIG. 3 illustrates a number of images of the computer model of FIG. 2 at incremental angular offsets from the initial orientation, about one of the x, y, or z axes.

FIG. 4 is a mockup prototype of a physical unit that could house a three-dimensional display system

FIG. 5 is a flowchart of a method for generating a simulated three-dimensional or holographic display.

Like reference symbols in the various drawings indicate like elements.

### DETAILED DESCRIPTION

This document describes multi-directional display. In some implementations, the multi-directional display is a variant of a simulated three-dimensional or holographic display that uses one or more flat panel displays that are rotated in synchronization with an image produced by a computer. In other words, a computer-generated display, from a known reference position, is synchronized to a rotation offset of the physical display. The computer-generated display can be produced by any graphics library, such as DirectX, OpenGL or other graphics library. The graphics display is generated in synchronization with a rotation of the display device.

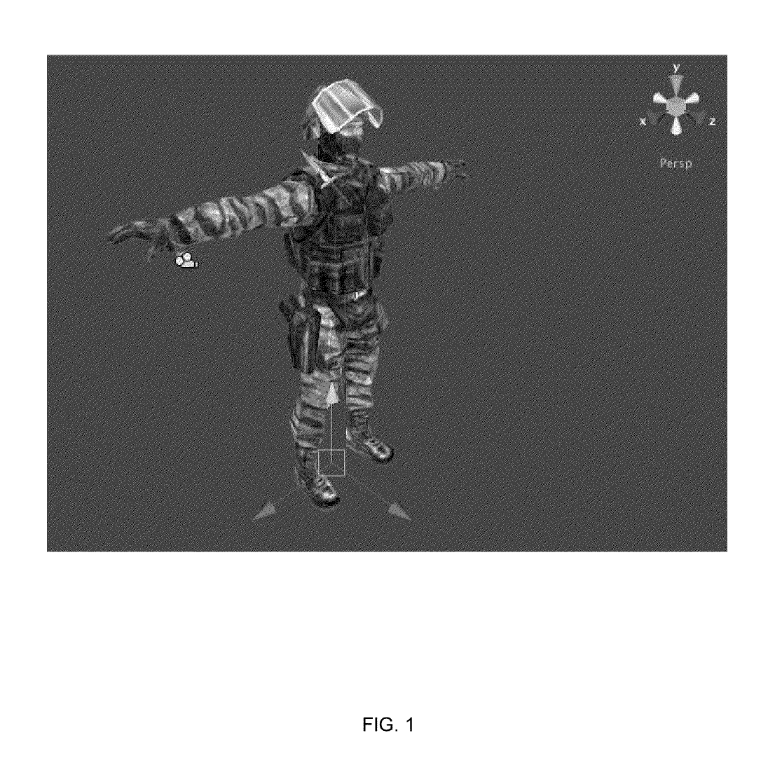

In reference to FIG. 1, an operation of the holographic display will now be described in terms of a computer-generated model (or “computer model”), a 2D image of a three-dimensional object. In this example, the computer model is of a soldier. However, those of relevant skill in the art will recognize that any computer model, or complex scene of models, can be used with the holographic display. The computer model is rendered and displayed on a physical electronic display, based on the X, Y and Z axes. The electronic display is described below in terms of a smart phone display device, which displays a computer model as if photographed at different angles of displacement by a virtual camera that moves around the modeled object at a fixed radial distance.

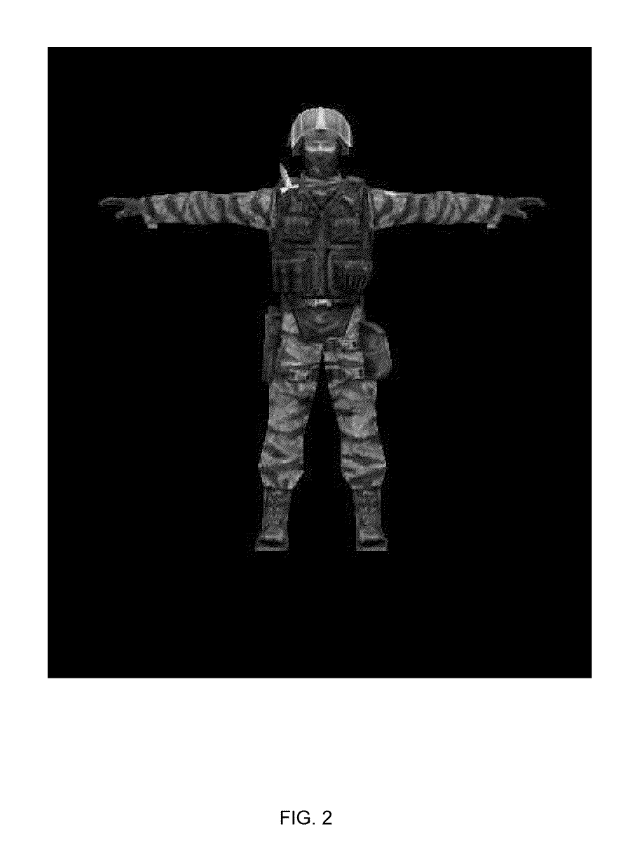

FIG. 2 illustrates an image of the computer model as if taken by a virtual camera directly in front of the computer model, which is considered to be the reference point with zero degree of displacement, i.e. initially at an imaginary origin, (i.e. x=0, y=0 and z=0), although any initial orientation can be used. The computer model is then rendered around a scene at a fixed radial distance but at different angles of displacement. The image rendered to the physical display is determined by an angle of the rotation platform to a known reference point.

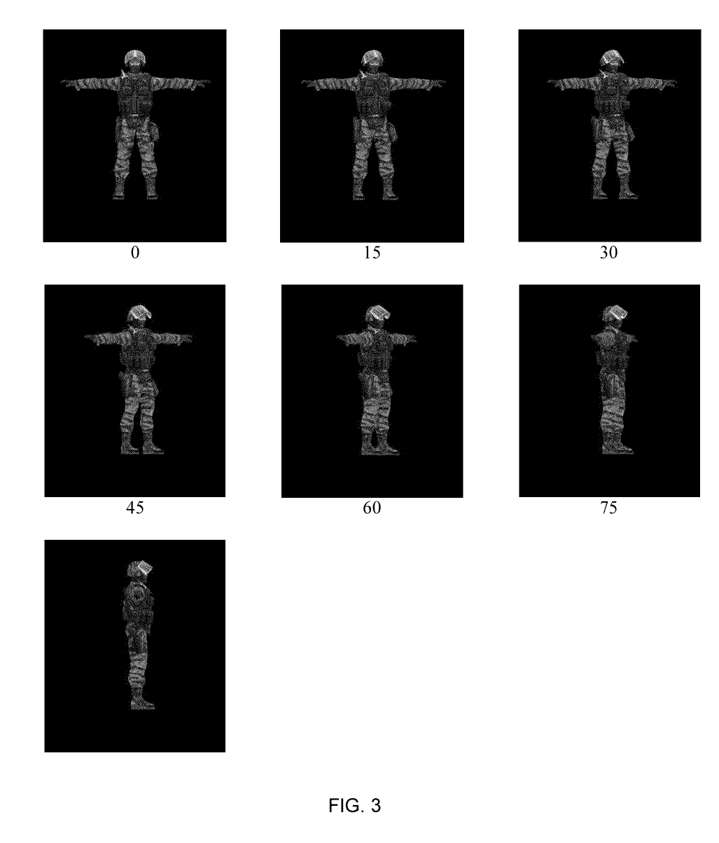

FIG. 3 shows the computer model with an increasing displacement angle at increments of 15 degrees, in this case around the y-axis, but which could be any of the three axes or combination of axes. If the images below were refreshed on the display with a high enough speed and fidelity in angle of displacement between pictures, the model would appear to be rotating in the y-axis within the confines of a two-dimensional flat screen.

To produce the desired three-dimensional effects, if the display is rotated 15 degrees in a counterclockwise direction around the y-axis, the sequence of display of the various incremental views of computer model must be 15 degrees in the clockwise direction around the y-axis. If the electronic display of the computer model continually rotates at the same magnitude but in the opposite direction of the sequence of displayed images, it will appear as though soldier is standing still: one could see all sides of the computer model by physically moving oneself to different angles relative to the display. By physically moving oneself from the front of the display to the back, a person would then see the back side of the soldier. The same would be true if person moved to the right or left.

If the angular velocity is increased to the point where the physical boundaries of the display (i.e. the out edges) are no longer clearly visible, the computer model will further take on the appearance of being a three-dimensional object, and the holographic display will give the illusion of a real object.

Just as sequential still frames displayed at high speeds will produce the illusion of motion, the physical rotation of a display, synchronized with an angular-displaced rendering of a computer-generated model displayed on a screen, will produce an illusion of a three-dimensional rendering with characteristics of height, width and depth.

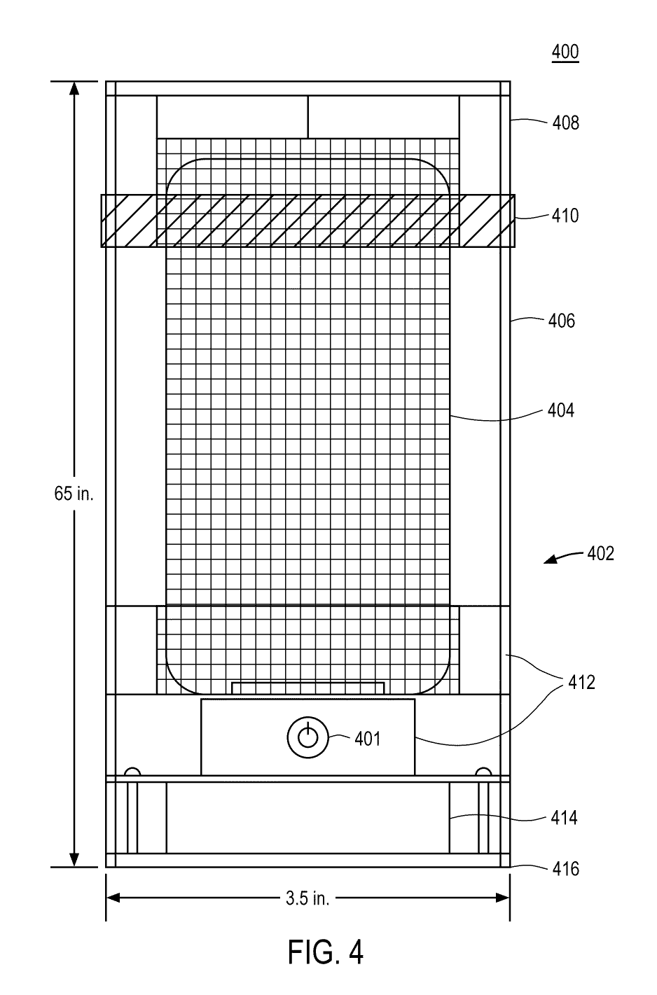

FIG. 4 illustrates an example of a holographic display system 400 that employs a display platform 402 to rotate at least one flat panel display 404 at a rate that is synchronized with a frame rate and angle of images generated of an object and displayed on the flat panel display 404. In preferred implementations, the display platform 402 includes a mounting mechanism 412 on which the flat panel display 404 is mounted, and a motor that rotates the mounting mechanism 412 at a controlled rate. In some implementations, the rate of rotation can be controlled to between 900 and 1,500 revolutions per minute (rpm). In other implementations, lower or higher speeds can be employed. For example, in one specific implementation, the rotation speed can be controlled to a rate between 120 and 7200 rpm.

In some preferred exemplary implementations, the flat panel display 404 is a touch screen-type display device as would be found on a conventional iPhone, iPod, or other smart phone or media player device. The display platform 402 can include a cylindrical sleeve 406 that is at least partially transparent, and preferably transparent all around the viewable area of the flat panel display 404. In some implementations, the sleeve 406 is transparent from all viewing angles, and the flat panel display 404 rotates inside of it, while in other implementations, the sleeve 406 rotates with the flat panel display 404.

The display platform 402 can further include a cap 406 that is coupled by threaded region 410 to the cylindrical sleeve 406. The cap 406 can be coupled by other coupling mechanism. The mounting mechanism 412 can include a dock with a data and electrical connection, as is found in conventional iPhone or iPod docking stations. The display platform 402 also includes a motor 414 attached to a non-moving base 416. The motor 414 rotates the mounting mechanism 412 to a rotation rate between 900 and 1,500 rpm. The motor 414 can be controlled by an external computer or other controller. In some implementations, the controller can include a control button 401 or switch for controlling one or more functions of the display platform 402.

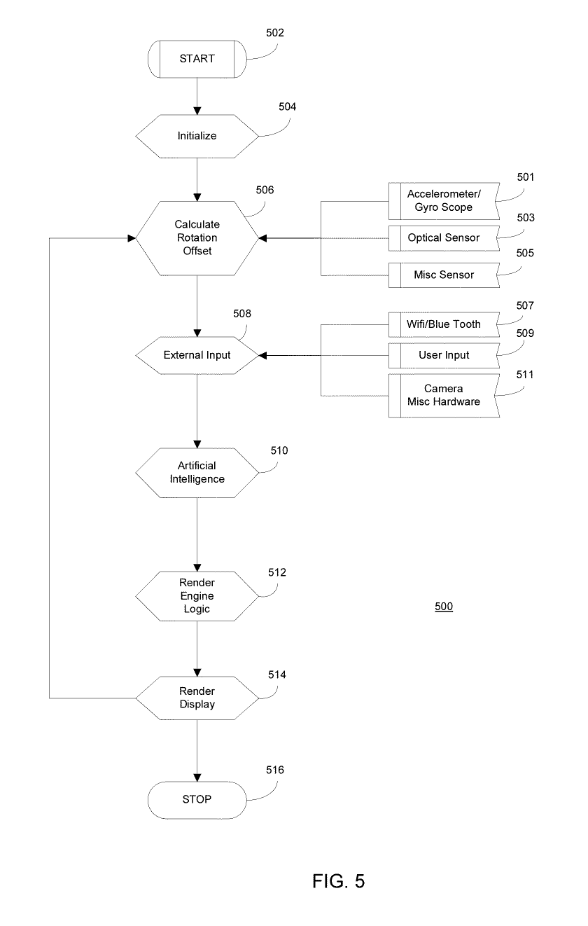

FIG. 5 is a flowchart of a method 500 for generating a simulated three-dimensional or holographic display, starting at 502, by controlling a display platform to operate a flat panel display substantially as described above and as follows. At 504, the display is initialized, such as a rendering of an object from an initial angle or view. At 506, a rotation offset is calculated, based on inputs including an accelerometer or gyroscope 501, optical sensor 503 and/or other sensor 505. At 508, external input is received by the display platform, including WIFI or Bluetooth data input 507, user input 509 such as can provided by a computer or other input device, and/or camera or other miscellaneous hardware 511. At 510, artificial intelligence is performed on the display platform, such as speed of rotation, number of frames per second to be displayed, display angle of the object to be rendered, etc. At 512, the artificial intelligence is used to provide the engine logic to control the display platform. At 514, the display is rendered by rotating the display synchronized with a frame rate and image angle of an object being displayed. The method 500 can repeat at 506, or stop at 516.

In another implementation, a multi-directional display is provided, which can be viewed from any direction around the screen. The multi-directional display takes advantage of high refresh rates of a video screen by rotating the screen around a vertical center axis (y-axis). At sufficiently high rotate rates, an image displayed on the rotating screen is visible 360 degrees around the display.

In preferred exemplary implementations, the multi-directional display uses the same physical setup as the holographic display described above. However, the image displayed on the screen need not be synchronized with a rate of rotation of the platform. Instead, the image displayed on the screen, and the refresh rate used to display the image, is independent of the viewing angle or angle of rotation. In some implementations, the multi-directional display rotates at a target rotational rate of 10-100 revolutions per second, and preferably at 24-40 revolutions per second, or even 24-30 revolutions per second.

The multi-directional display can be implemented by one or more computers and computer displays. Using a computer to manipulate the display enables a single object (soda can, model, car, etc) to be displayed. Providing the rotation speed of the screen to correspond with a refresh rates enables the object to appear to be floating in the air, and provides three-dimensional characteristics, giving the impression of a hologram. The objects can be animated by traditional computer methods, and with the addition of holographic characteristics, entices the user to watch longer and with greater attention.

Referring back to FIG. 1, shown is an image of a computer model of a soldier. This shows the references axis: x, y, z. The multi-directional display includes primarily rotation around the y-axis. The image of FIG. 2 shows the front view of the same soldier. As a simple example, the image of FIG. 1 can be displayed on a computer screen, and the computer screen is rotated such that the center of the image rotates in alignment with the axis of rotation of the physical platform. When the image on the screen is viewed, the same image of the soldier is viewable from any angle around the display platform. To eliminate possible streaking or ghosting, as might appear at high rotation speeds, a physical privacy filter overlay, or other physical barrier to limit a viewing angle from any particular position, can be used, but which will not limit the multi-directional viewing angle of the display system overall.

The multi-directional display described above is applicable to any screen technology. For example, a flat screen television can be rotated at high speeds around the vertical axis. This allows an image on the screen (i.e., television program, news broadcast, etc) to be visible from any angle around the display. The multi-directional display eliminates the need for multiple screens to display a common image, and overcomes a limited viewing angle provided by traditional screens. The multi-directional display provides a viewing angle to encompass the full 360 degrees (i.e., full circle) around the platform. In other words, no matter how the display is rotated, the image will be visible. Further, objects displayed in the multi-directional screen can appear to be three-dimensional, i.e. essentially becoming what most people consider to be a hologram.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A method for generating a multi-directional display, the method comprising:
generating an image on a screen, the screen having an image refresh rate, an x-axis and a y-axis defining the height and length of the screen, respectively, and a z-axis orthogonal to the screen; and
rotating the screen about the x-axis at a rotational speed relative to the image refresh rate, such that the image on the screen is visible at the z-axis in all directions around the screen.

2. The method in accordance with claim 1, wherein the image includes a set of images forming a video image, the set of images being displayed at a rate that is less than the image refresh rate.

3. The method in accordance with claim 1, wherein the image refresh rate is at least 240 Hz.

4. The method in accordance with claim 1, wherein the rotational speed of the screen is 10 to 40 revolutions per second.

5. The method in accordance with claim 4, wherein the rotational speed of the screen is 24 to 30 revolutions per second.

6. A system for generating a multi-directional display, the system comprising:
an electronic display that displays an image on a screen, the screen having an image refresh rate, an x-axis and a y-axis defining the height and length of the screen, respectively, and a z-axis orthogonal to the screen; and
a rotation mechanism that rotates the electronic display at a rotational rate that is related to the image refresh rate.

7. The system in accordance with claim 6, wherein the image includes a set of images forming a video image, the set of images being displayed at a rate that is less than the image refresh rate.

8. The system in accordance with claim 6, wherein the image refresh rate is at least 240 Hz.

9. The system in accordance with claim 6, wherein the rotational speed of the screen is 10 to 40 revolutions per second.

10. The system in accordance with claim 9, wherein the rotational speed of the screen is 24 to 30 revolutions per second.
